(19) United States
(12) Patent Application Publication
(10) Pub. No.: US 2006/0190547 A1
(43) Pub. Date: Aug. 24, 2006

(54) Method and apparatus for restricting instant messaging during a scheduled event

(75) Inventors: Kulvir Singh Bhogal, Fort Worth, TX (US); Robert J. Kamper, Round Rock, TX (US)

Correspondence Address: MARK P. KAHLER, 8101 VAILVIEW COVE, AUSTIN, TX, 78750, US

(73) Assignee: IBM Corporation, Austin, TX (US)

(21) Appl. No.: 11/064,921

(22) Filed: Feb. 24, 2005

(51) Int. Cl. G06F 15/16

(52) U.S. Cl. 709/207

(57) ABSTRACT

An instant messaging (IM) client-server network system includes a calendar server and an IM server in one embodiment. The calendar server stores calendars including events and lists of attendees for respective events. The calendar server also stores IM restriction information that specifies limitation of the IM capabilities of attendees of a particular event. In one embodiment, an event organizer inputs the IM restriction information. In another embodiment, an event attendee inputs IM restriction information that limits the IM capability of that particular attendee. When the time of a calendared event arrives, the calendar server sends the IM restriction information associated with that event to the IM server. The IM server enforces the IM restrictions associated with the IM restriction information during the particular event. When the event is over, the IM server restores full IM capability to the attendees of the event.

### CROSS REFERENCE TO RELATED PATENT APPLICATIONS

This patent application relates to the U.S. Patent Application entitled “Method and Apparatus For Task Scheduling In An Instant Messaging Environment”, inventors Kulvir Singh Bhogal and Robert J. Kamper, Attorney Docket No. AUS9-2004-0761 (S.N. to be assigned, filed on the same day as the subject patent application, and assigned to the same assignee), the disclosure of which is incorporated herein by reference in its entirety.

This patent application relates to the U.S. Patent Application entitled “Method and Apparatus For Communicating Multiple Activity Availability Status In An Instant Messaging Environment”, inventors Kulvir Singh Bhogal and Robert J. Kamper, Attorney Docket No. AUS9-2004-0762 (S.N. to be assigned, filed on the same day as the subject patent application, and assigned to the same assignee), the disclosure of which is incorporated herein by reference in its entirety.

This patent application relates to the U.S. Patent Application entitled “Method and Apparatus For Updating Information Stored In Multiple Information Handling Systems”, inventors Kulvir Singh Bhogal and Robert J. Kamper, Attorney Docket No. AUS9-2004-0763 (S.N. to be assigned, filed on the same day as the subject patent application, and assigned to the same assignee), the disclosure of which is incorporated herein by reference in its entirety.

This patent application relates to the U.S. Patent Application entitled “Method and Apparatus For Forwarding User Information Among Multiple Information Handling Systems”, inventors Kulvir Singh Bhogal and Robert J. Kamper, Attorney Docket No. AUS9-2004-1037 (S.N. to be assigned, filed on the same day as the subject patent application, and assigned to the same assignee), the disclosure of which is incorporated herein by reference in its entirety.

### TECHNICAL FIELD OF THE INVENTION

The disclosures herein relate generally to the communication of information in a networked environment and, more particularly, to the control of instant messaging activities in an instant messaging environment.

### BACKGROUND

Networked systems of interconnected web servers, application servers and client devices continue to grow and proliferate. Local area networks, wide area networks, intranets and the Internet connect servers and client devices to form these networked systems. In businesses, homes and other entities, users now communicate via networked systems that provide electronic mail (e-mail), instant messaging (IM) as well as electronic calendaring or scheduling of events.

While e-mail provides an acceptable way to communicate for both business and personal purposes, it lacks the immediacy of real-time communication. In contrast, instant messaging (IM) software provides the immediacy lacking in e-mail communications. Instant messaging (IM) software notifies client devices when friends or colleagues appear online and allows client devices to communicate with one another in real-time via online chat sessions. A particular client device user may desire to inform other client device users that the particular client device user is online but not currently available for IM communication. In one example of conventional instant messaging, the user manually types his or her availability status, namely a busy notice, into the instant messaging client software installed on the client device. For example, such a busy notice can take the form “User Mary is in a meeting—do not disturb.” The instant messaging client software sends the busy notice via an IM server to users of other client devices in the same IM session. In response, the other users' client devices display an IM panel or window that includes the busy notice next to User Mary's name. In this manner the displayed busy notice apprises the other users that the particular user is online but not currently available. When the particular user again becomes available, that user manually instructs the IM software to change availability status from “online but unavailable” to “online and available”. Due to the inconvenience of manually typing availability status changes in IM software, many users do not bother changing their availability status. Consequently, one user may try to IM another user when the other user appears online but is not actually available.

Contemporary business meetings often include many participants who bring their laptop, notebook, PDA or other portable client devices with them to the meeting. This may increase the productivity of some participants. However, when these client devices employ instant messaging during the meeting, participants may be frequently interrupted by instant messages. These distractions can decrease the productivity of the meeting.

What is needed is a method and apparatus that avoids the above problems associated with distractions caused by IM activities during calendared events such as meetings.

### SUMMARY

Accordingly, in one embodiment, a method is disclosed for operating instant messaging in a network including plurality of client devices. The method includes scheduling, by a calendar server application, an event in which instant messaging (IM) users participate as event attendees via the client devices. The method also includes transmitting, by the calendar server application, IM restriction information to an IM server application. The method further includes restricting, by the IM server application, the IM capability of event attendees' client devices during the event as specified by the IM restriction information. In more detail, prior to the scheduled event, an event organizer inputs the IM restriction information into the calendar server application. The calendar server application associates the IM restriction information with a corresponding scheduled event. When the time for the scheduled event occurs, the calendar server application sends the associated IM restriction information to the IM server application. The IM server application then enforces the IM restrictions specified in the IM restriction information for the duration of the event.

In another embodiment, a network system is disclosed that includes a server and client devices that are couplable to the server. The server includes a server processor. The server also includes a server storage, coupled to the server processor, containing application code that when executed by the server processor enables the following actions. The application code enables hosting, by the server, an instant messaging session in which the client devices participate, the client devices being operable by respective client device users. The application code also enables storing, by the server, calendars of events for the respective client device users, the calendars including a list of attendees for a particular event. The application code further enables storing, by the server, IM restriction information that limits IM activity of attendees during the particular event. The application code still further enables monitoring, by the server, the calendars of events to determine if any of the client device users is scheduled as an attendee for the particular event at the present time. The application code also enables transmitting, by the server, the IM restriction information to the client devices of users scheduled as attendees of the particular event to limit the IM activity of the attendees during the event.

### BRIEF DESCRIPTION OF THE DRAWINGS

The appended drawings illustrate only exemplary embodiments of the invention and therefore do not limit its scope because the inventive concepts lend themselves to other equally effective embodiments.

FIG. 1 shows a block diagram of one embodiment of the disclosed networked system.

FIG. 2 shows a block diagram of a general purpose information handling system that can be used as clients and servers in the disclosed system.

FIG. 3A shows a representative event scheduling window on the display of an event organizer's client device.

FIG. 3B shows a representative event organizer's RESTRICT IM window prior to the organizer filling in the window with IM restriction information.

FIG. 3C shows the event organizer's calendar event scheduling window after the event organizer inputs the desired subject, place, date and begin time, date and end time, and list of invited attendees.

FIG. 3D shows a RESTRICT IM window wherein the event organizer checked or selected the DISABLE ALL IM DURING EVENT checkbox.

FIG. 3E shows a RESTRICT IM window wherein the event organizer checked or selected the ALLOW IM AMONG EVENT ATTENDEES ONLY checkbox.

FIG. 3F shows a RESTRICT IM window wherein the event organizer, or event chair, checks or selects options in the SELECTIVE IM RESTRICTION panel of the RESTRICT IM window.

FIG. 4 shows a representative event invitation that the organizer's IM application distributes to the attendees specified in event scheduling window.

FIGS. 5A and 5B together show a flowchart that describes the operational flow exhibited by the networked system when it collects IM restriction information from users.

FIG. 6 shows a flowchart that depicts the operation of the calendar server and the IM server of the disclosed networked system when it carries out the IM restrictions specified in IM restriction information.

### DETAILED DESCRIPTION

The disclosed networked system provides an event organizer or event chair with the ability to restrict instant messaging during a calendared event such as a meeting. The networked system can decrease meeting interruptions that might otherwise result from IM activities of meeting participants who employ networked client devices during the meeting.

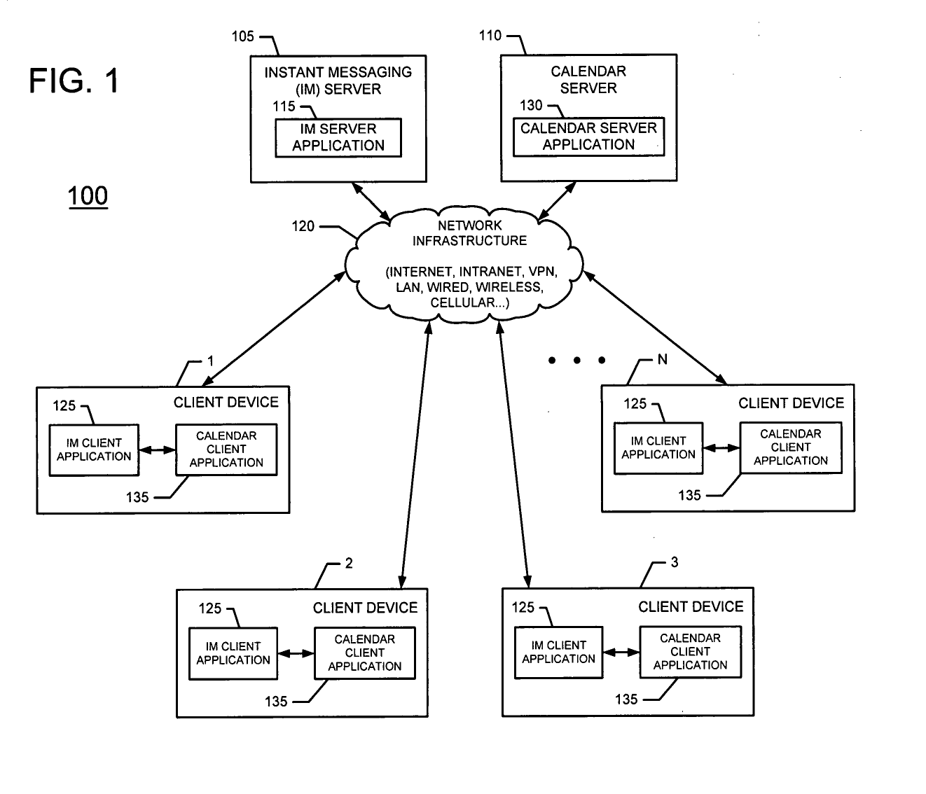

FIG. 1 shows a block diagram of a representative networked system 100 that employs the disclosed technology. System 100 includes an instant messaging (IM) server 105 and a calendar server 110. Instant messaging server 105 hosts an IM server application 115 that enables client devices such as client devices 1, 2, 3 . . . N to communicate with one another via real-time instant messaging sessions. Client devices 1, 2, 3 . . . N include personal computer systems, laptops, notebooks, personal digital assistants and other devices coupled together to communicate information. More specifically, network infrastructure 120 couples together IM server 105, calendar server 110 and client devices 1, 2, 3 . . . N. Network infrastructure 120 may include networking structures such as the Internet, an intranet, virtual private network (VPN), wire-based networking structures and wireless networking structures. Each client device 1, 2, 3 . . . N includes an instant messaging client application 125 that enables a client device to communicate in real-time with an instant messaging application on another client device via IM server application 115 and network infrastructure 120. IM client applications 125 in client devices 1, 2, 3 . . . N transmit messages and files among one another. Each client device 1, 2, 3 . . . N includes a display (not shown) that displays messages received from other users. Typically a message includes the user's name and textual content that the user inputs into his or her client device. In one embodiment, the display in each client device displays the textual content adjacent the corresponding user's name. In actual practice, a single server can include both IM server 105 and calendar server 110.

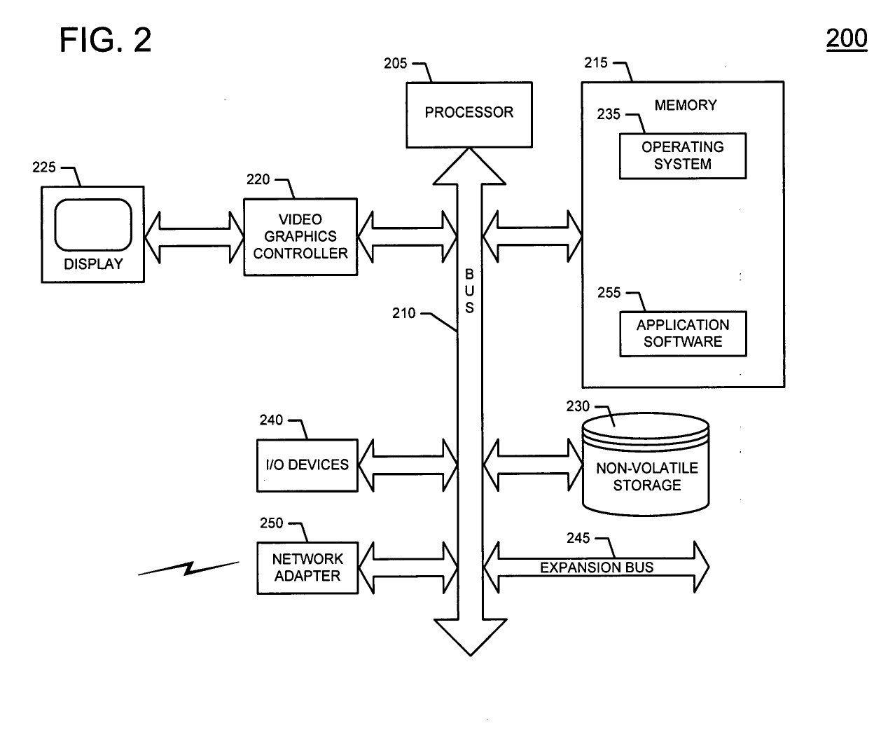

FIG. 2 shows a general purpose information handling system (IHS) 200 that system 100 can employ as instant messaging server 105, calendar application server 110 and client devices 1,2, 3 . . . N. Information handling system (IHS) 200 includes a processor 205. Bus 210 couples processor 205 to system memory 215 and video graphics controller 220. A display 225 couples to video graphics controller 220. Nonvolatile storage 230, such as a hard disk drive, CD drive, DVD drive, or other nonvolatile storage couples to bus 210 to provide IHS 200 with permanent storage of information. An operating system 235 loads in memory 215 to govern the operation of IHS 200. I/O devices 240, such as a keyboard and a mouse pointing device, couple to bus 210. One or more expansion busses 245, such as USB, IEEE 1394 bus, ATA, SATA, PCI, PCIE and other busses, couple to bus 210 to facilitate the connection of peripherals and devices to IHS 200. A network adapter 250 couples to bus 210 to enable IHS 200 to connect by wire or wirelessly to network infrastructures such as network infrastructure 120 shown in FIG. 1.

IHS 200 loads application software 255 from nonvolatile storage 230 to memory 215 for execution. The particular application software 255 loaded into memory 215 of IHS 200 determines the operational characteristics of IHS 200. IHS 200 is configurable as an instant messaging server 105, a calendar application server 110 and as client devices 1, 2, 3 . . . N. When IHS 200 acts as instant messaging server 105, IHS 200 loads IM server application 115 into system memory 215. Similarly, when IHS 200 acts as a calendar application server 110, IHS 200 loads calendar server application 130 into system memory 215. When IHS 200 acts as client devices 1, 2, 3 . . . N with instant messaging and calendaring capabilities, IHS 200 loads IM client application 125 and calendar client application 135 into system memory 215.

Calendar application server 110 hosts a calendar server application 130 that communicates with calendar client applications 135 in client devices 1, 2, 3 . . . N. Calendar application 130 also communicates with IM server application 115. The calendar client application 135 in a particular client device communicates with calendar application 130 in calendar server 110. Calendar server application 130 and calendar client applications 135 together maintain respective calendars for users 1, 2, 3 . . . N. Typically, calendar server application 130 stores calendars for all users, while respective calendar client applications 135 in client devices 1, 2, 3 . . . N store the calendar of the particular user associated with the respective client device. Calendar server application 130 in calendar application server 110 coordinates the calendar client applications of the respective client devices 1, 2, 3 . . . N.

Calendar server application 130 operates in cooperation with calendar client application 135 and IM server application 115 to provide an event organizer such as a chairperson, coordinator or designee with the ability to restrict the IM capabilities of attendees of a scheduled event. Scheduled events include meetings, both online and physical gatherings, and other gatherings of attendees. Event attendees include attendees of online events as well as attendees of events at a common physical locus. In one embodiment, calendar server application 130 operates in cooperation with calendar client application 135 and IM server application 115 to provide a prospective attendee or invitee with the ability to restrict his or her IM capability during a scheduled event.

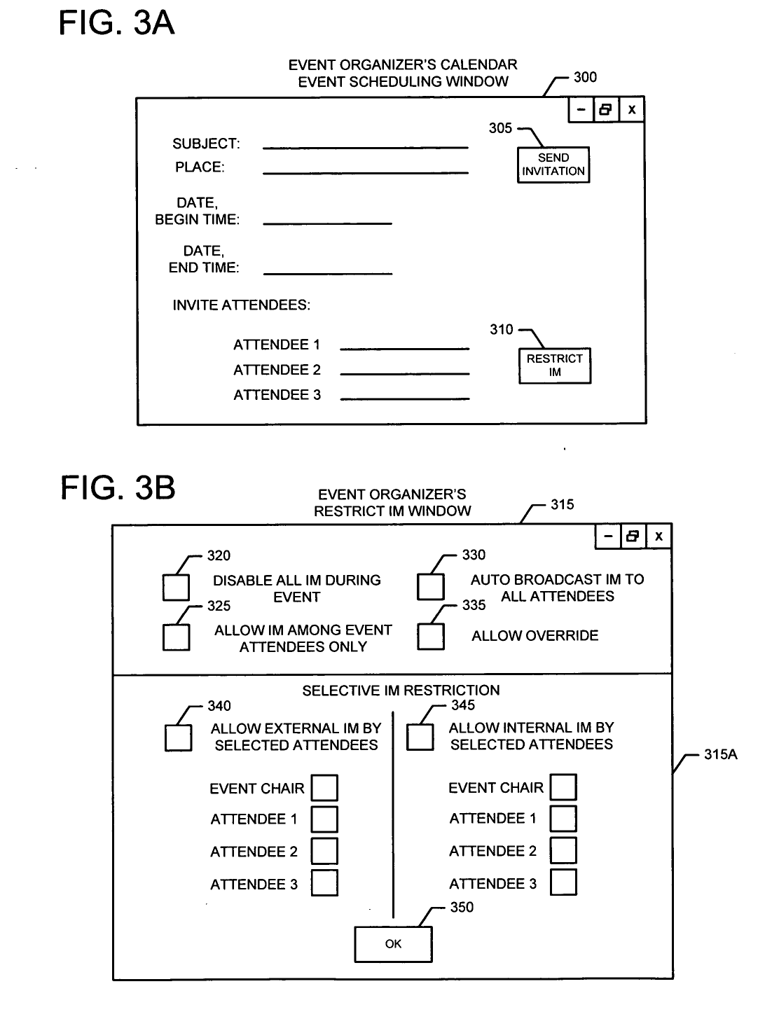

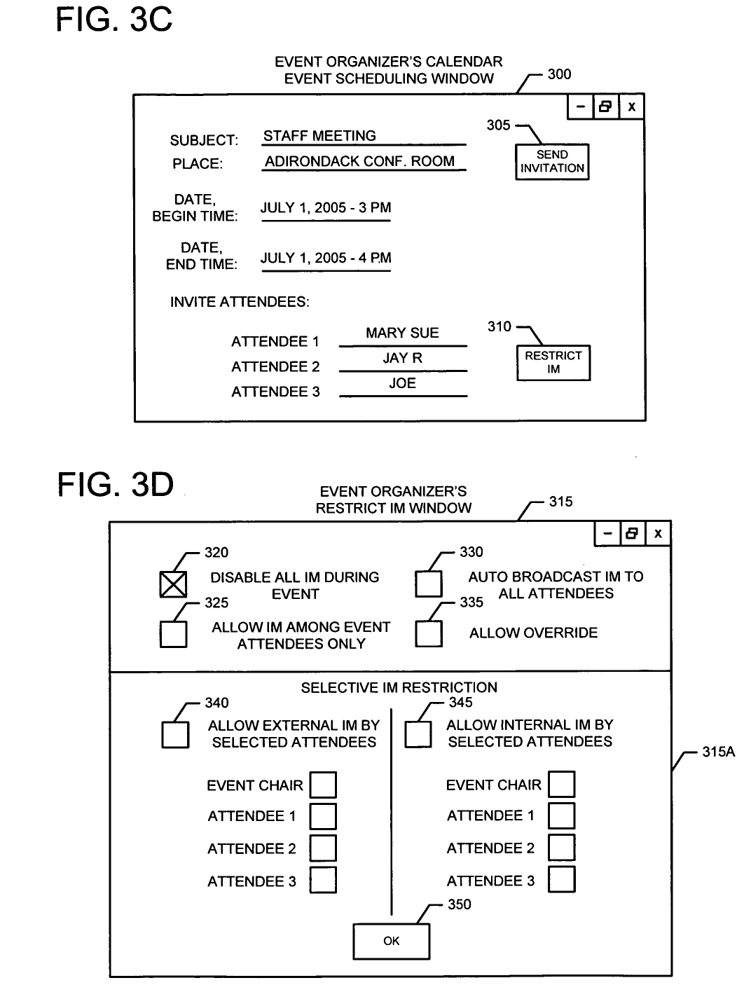

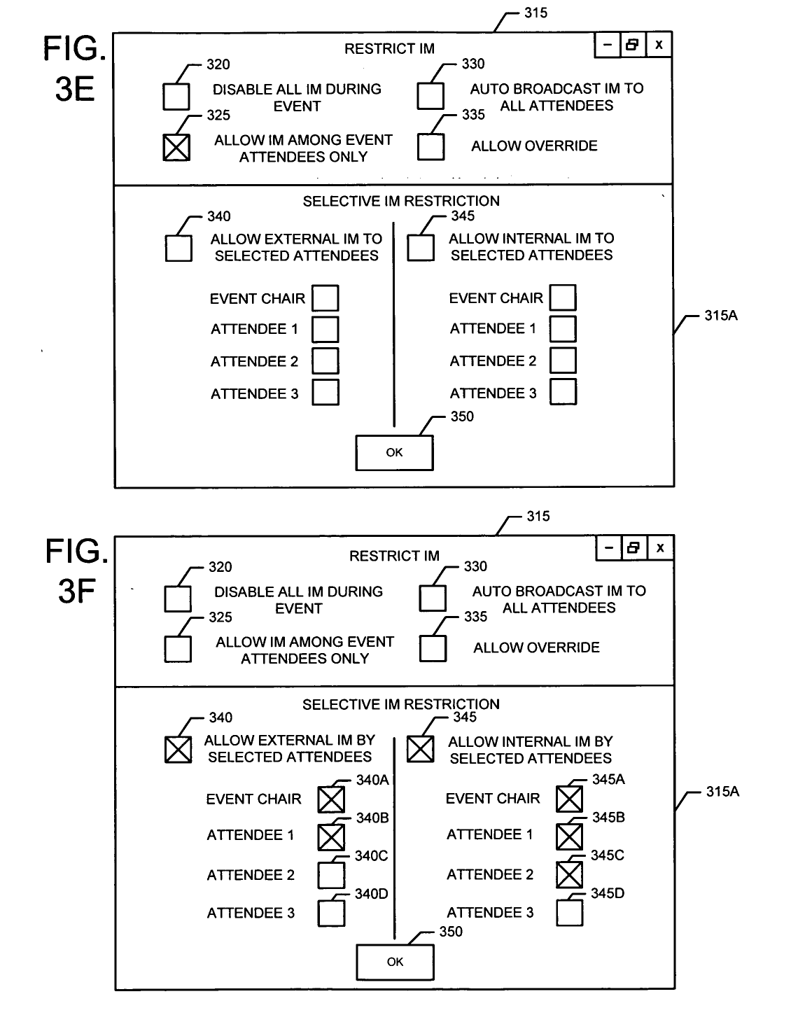

FIG. 3A shows a representative event scheduling window 300 on the display of an event organizer using one of client devices 1, 2, 3 . . . N to schedule an event via calendar client application 135 operating in cooperation with calendar server application 130. The event organizer, or the organizer's delegate, accesses window 300 to schedule and invite attendees to an event. Calendar client application 135 generates event scheduling window 300 and communicates event information elicited from the event organizer to calendar server application 130 for storage and handling. Event scheduling window 300 includes fields for event information such as the subject, place, date and begin time, and the date and end time of the event. Event scheduling window 300 also includes attendee fields, for example attendee 1 field, attendee 2 field and attendee 3 field. Once the event organizer completes these fields, event scheduling window 300 presents the organizer with two choices, namely to select SEND INVITATION button 305 or RESTRICT IM button 310. If the organizer does not intend to restrict the IM capabilities of attendees, then the organizer selects the SEND INVITATION button 305. However, if the organizer desires to restrict the IM capabilities of attendees during the event, then the organizer selects RESTRICT IM button 310. In an alternative embodiment, for event organizers with managerial status within an organization, a manager event organizer can restrict the IM capability of any attendee reporting to the manager in an organization chart stored in calendar server 110 or other convenient location in networked system 100.

FIG. 3B shows the event organizer's RESTRICT IM window 315 that calendar client application 135 generates in cooperation with calendar server application 130 when the event organizer selects RESTRICT IM button 310. RESTRICT IM window 315 includes checkboxes that the organizer can select to activate corresponding functions indicated by the titles of the respective checkboxes. More specifically, RESTRICT IM window 315 includes a DISABLE ALL IM DURING EVENT checkbox 320. When the event organizer checks the DISABLE ALL IM DURING EVENT checkbox 320, this action instructs calendar server application 130 and IM server application 115 to not allow any IM activity by attendees during the event. In other words, server applications 130 and 115 permit neither internal IM, i.e. IM by attendees with other attendees of the event, nor external IM, i.e. IM by attendees of an event with users outside of the event. In this scenario, IM server application 115 or local IM client application 125 generates a “Busy—Attending Scheduled Event” notice. This busy notice appears adjacent the busy attendee's name in an IM window on the displays of the client devices of other users participating in same IM session as the attendee. Alternatively, the IM server application 115 in cooperation with IM client application 125 shows the busy attendee to be offline during the event. When the organizer selects a particular checkbox, an X appears in the checkbox to signify the selection.

The RESTRICT IM window 315 also includes an ALLOW IM AMONG EVENT ATTENDEES ONLY checkbox 325. When the event organizer checks checkbox 325, then calendar server application 130, IM server application 115 and IM client applications 125 restrict the attendees to internal IM, namely the attendees can IM only one another during the event. In other words, system 100 does not permit external IM during the scheduled event. The RESTRICT IM window 315 further includes an AUTO BROADCAST IM TO ALL ATTENDEES checkbox 330. When the event organizer checks or selects checkbox 330, then calendar server application 130, IM server application 115 and IM client applications 125 cooperate to automatically transmit IM messages from one attendee to all attendees during the meeting. The restrict IM window 315 also includes an ALLOW OVERRIDE checkbox 335. As explained above, when the event organizer restricts IM by checking either checkbox 320 or checkbox 325, system 100 restricts the IM capability of attendees during an event accordingly. If a non-attendee attempts to IM an attendee during an event, system 100 prevents such an attempt from succeeding. However, if the event organizer checks ALLOW OVERRIDE checkbox 335, then system 100 notifies the non-attendee of the IM restriction during the event, but allows the non-attendee to override the restriction and contact an attendee for urgent matters.

The RESTRICT IM window 315 also includes an ALLOW EXTERNAL IM BY SELECTED ATTENDEES checkbox 340 in a SELECTIVE IM RESTRICTION panel 315A. The event organizer may select checkbox 340 and then select the particular attendees for whom system 100 permits external IM'ing during the event. For example, the event organizer may select one or more of the event attendees, such as the event organizer (namely the event chair or delegate), attendee 1, attendee 2 and attendee 3 to participate in external IM'ing during the event. While the example in FIG. 3B shows only 4 attendees (including the event organizer), the restrict IM window 315 may also include a larger or smaller number of attendees. Of course, at last 2 attendees are needed for an event or meeting in one embodiment.

The RESTRICT IM window 315 also includes an ALLOW INTERNAL IM BY SELECTED ATTENDEES checkbox 345 in SELECTIVE IM RESTRICTION panel 315A. The event organizer may select checkbox 345 and then select the particular attendees for whom system 100 permits internal IM'ing during the event. For example, in this particular case, the event organizer may select one or more of the event chair, attendee 1, attendee 2 and attendee 3 to participate in internal IM'ing during the event. System 100 prevents those attendees not selected from internal IM'ing during the meeting. When the event organizer finishes making selections in restrict IM window 315, then the event organizer indicates approval of the selections by selecting OK button 350. The display of the event organizer's client device returns to event scheduling window 300 of FIG. 3A when the event organizer selects OK button 350. The event organizer may then select SEND INVITATION button 305 to initiate distribution of event invitations to the prospective attendees.

FIG. 3C shows the event organizer's calendar event scheduling window 300 after the event organizer inputs the desired subject, place, date and begin time, date and end time, and list of invited attendees. After populating the event invitation window in this manner, the organizer selects SEND INVITATION button 305 or RESTRICT IM button 310. If the organizer selects SEND INVITATION button 305, then the organizer's calendar client application 135 in cooperation with IM server application 115 distributes an event invitation to the specified attendees. In this scenario, system 100 does not restrict IM'ing activity by the specified attendees. However, if the organizer selects restrict IM button 310, then the organizer's client device, for example client device 1, displays the restrict IM window 315.

FIG. 3D shows a restrict IM window 315 wherein the event organizer checked or selected the DISABLE ALL IM DURING EVENT checkbox 320. In response to selecting checkbox 320 and subsequently selecting OK button 350, the organizer's client device 1 returns to event scheduling window 300 of FIG. 3C. When the organizer subsequently selects the SEND INVITATION button 305, system 100 distributes event invitations to the attendees specified by the organizer in event scheduling window 300. System 100 then enforces the particular IM restriction or restrictions selected by the event organizer, namely to disable all IM during the event in this particular example.

FIG. 3E shows a restrict IM window 315 wherein the event organizer checked or selected the ALLOW IM AMONG EVENT ATTENDEES ONLY checkbox 325. In response to selecting checkbox 325 and subsequently selecting OK button 350, the organizer's client device 1 returns to event scheduling window 300 of FIG. 3C. When the organizer subsequently selects the SEND INVITATION button 305, system 100 distributes event invitations to the attendees specified by the organizer in event scheduling window 300. System 100 then enforces the particular IM restriction or restrictions selected by the event organizer, namely to allow IM among event attendees only in this example.

FIG. 3F shows a restrict IM window 315 wherein the event organizer, or event chair, checks or selects options in SELECTIVE IM RESTRICTION panel 315A of window 315. In this particular example, the organizer selects both the ALLOW EXTERNAL IM BY SELECTED ATTENDEES checkbox is 340 and the ALLOW INTERNAL IM BY SELECTED ATTENDEES checkbox 345. To allow external IM to selected attendees, namely the organizer (event chair) and attendee 1, the organizer selects checkboxes 340A and 340B as indicated by the respective X's therein. To allow internal IM to selected attendees, namely the organizer (event chair), attendee 1 and attendee 2, the organizer selects checkboxes 345A, 345B and 345C as indicated by the respective X's therein. In response to selecting checkboxes 340, 345, 340A, 340B, 345A, 345B and 345C, and subsequently selecting OK button 350, the display of the organizer's client device 1 returns to event scheduling window 300 of FIG. 3C. When the organizer subsequently selects the SEND INVITATION button 305, system 100 distributes event invitations to the attendees specified by the organizer in event scheduling window 300. System 100 then enforces the particular IM restriction or restrictions selected by the event organizer, namely to allow external IM by one group of specified event attendees and to allow internal IM among a second group of specified event attendees. The first and second groups of event attendees may have some attendees in common or no attendees in common.

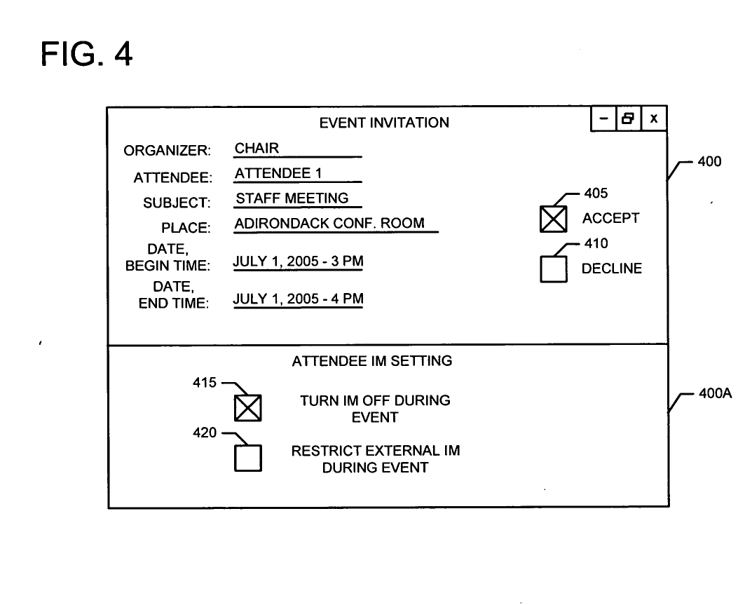

FIG. 4 shows a representative event invitation 400 that the organizer's calendar client application 135, in cooperation with calendar server application 130, distributes or transmits to the attendees specified in event scheduling window 300 of FIG. 3A. The event invitation 400 includes completed fields for the organizer, prospective attendee or invitee, subject, place, date and begin time, as well as date and end time. The attendee may accept the invitation by selecting ACCEPT checkbox 405. Alternatively, the attendee may decline the invitation by selecting DECLINE checkbox 410. Event invitation window 400 includes an attendee IM setting panel 400A wherein the attendee restricts or otherwise specifies his or her IM status during the event associated with the subject invitation. The settings prescribed in IM setting panel 400A affect the status of the attendee associated with the particular invitation and does not affect the status of other attendees. IM setting panel 400A includes a TURN IM OFF DURING EVENT checkbox 415 and a RESTRICT EXTERNAL IM DURING EVENT checkbox 420. When the attendee selects checkbox 415, all IM activity for that particular attendee ceases for the duration of the event. In other words, system 100 precludes both IM activity internal to the event for that particular attendee, namely IM between the particular attendee and other event attendees, as well as IM activity external to the event, namely IM activity between the particular attendee and IM users not participating in the event. However, if the attendee selects checkbox 420, system 100 precludes IM activity external to the event, namely between that attendee and those external to the event. When the attendee concurs with the attendee IM settings of attendee IM setting panel 400A, the attendee selects ACCEPT checkbox 405. The calendar client application 135 of the prospective attendee's client device then sends the accepted invitation back to calendar server application 130 along with the IM restriction settings requested by the attendee. In an alternative embodiment, system 100 provides a modified attendee IM setting panel 400A that allows the attendee to specify a particular user or users who may interrupt the attendee during the event despite an IM restriction during the event. In another alternative embodiment, system 100 provides a modified scheduling window 300 including a request checkbox that, when selected by the meeting organizer, instructs system 100 to request that attendees voluntarily restrict IM during the scheduled event. In this scenario, system 100 includes such a voluntary IM restriction request in the invitations sent to attendees.

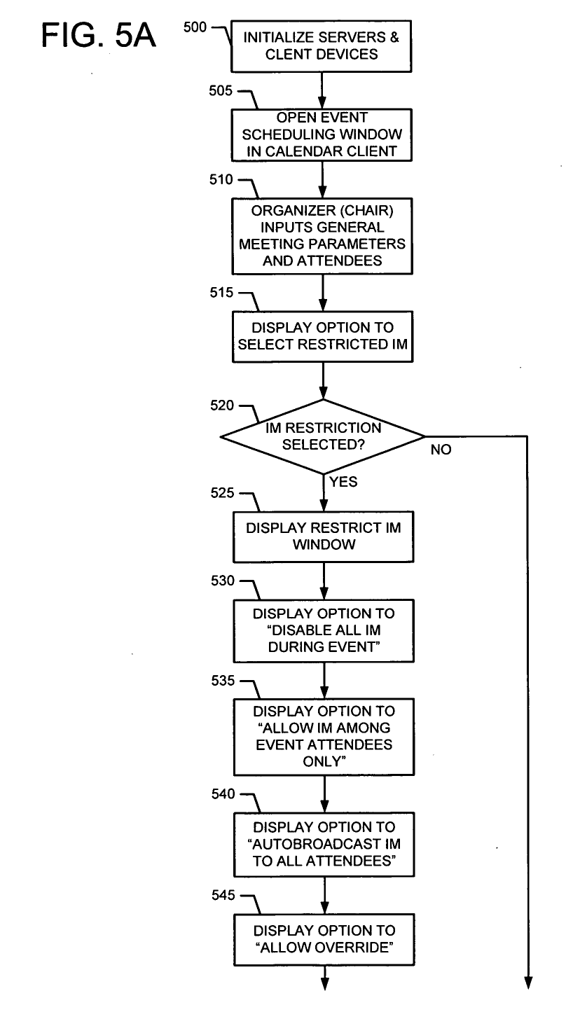

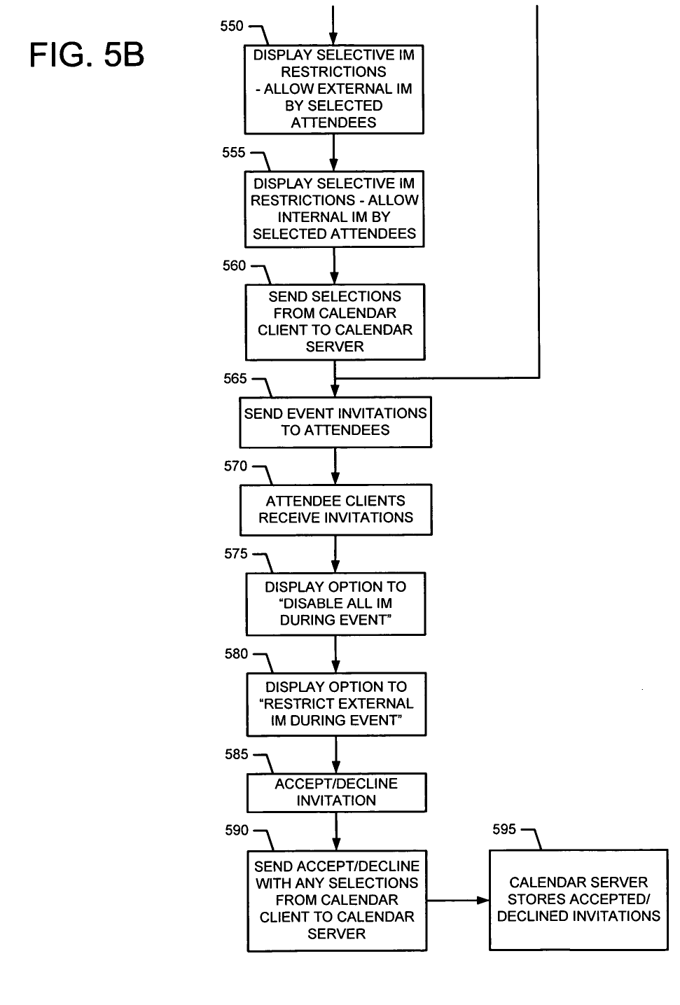

FIGS. 5A and 5B together show a flowchart that describes the operational flow exhibited by system 100 when it implements the disclosed IM restriction technology. Operation commences when IM server 105, calendar server 110 and client devices 1, 2, 3 . . . N initialize as per block 500. To schedule an event such as a meeting, the event organizer opens event scheduling window 300 in calendar client application 135 of the organizer's client device as per block 505. The event organizer, such as an event chairperson or designee, inputs general event parameters or information such as subject, place, begin time and date, and end time and date, as well as prospective attendees into respective fields in event scheduling window 300 as per block 510.

The organizer's client device displays a RESTRICT IM button 310 that provides the organizer with the option to restrict the IM capabilities of prospective attendees as per block 515. Calendar client application 135 of the organizer's client device conducts a test to determine if the organizer selected the IM restriction option as per block 520. If calendar client application 135 determines that the organizer selected the IM restriction option, then calendar client application 135 opens a restrict IM window 315 on the organizer's client device as per block 525.

The organizer's client device displays an option to DISABLE ALL IM DURING EVENT in the restrict IM window 315 as per block 530. The organizer's client device also displays an option to ALLOW IM AMONG EVENT ATTENDEES ONLY as per block 535. The organizer's client device further displays an option to AUTO BROADCAST IM TO ALL ATTENDEES as per block 540. The organizer's client device also displays an option to ALLOW OVERRIDE as per block 545. The options displayed in blocks 530, 535, 540 and 545 appear in restrict IM window 315 in this particular embodiment.

FIG. 5B shows a continuation of the flowchart of FIG. 5A. The organizer's client device also displays selective IM restrictions in panel 315A as discussed above. More particularly, the organizer's client device displays an ALLOW EXTERNAL IM BY SELECTED ATTENDEES option 340 as per block 550. The same client device also displays an ALLOW INTERNAL IM BY SELECTED ATTENDEES option 345 as per block 555. These additional options appear in restrict IM window 315 on the display of the organizer's client device. The organizer makes his or her selections in restrict IM window 315 and event scheduling window 300. The organizer's client device then sends these selections from the organizer's calendar client application 135 to calendar server 110 as per block 560.

Calendar client application 135 or calendar server application 110 then sends the invitation specified by the event organizer to the prospective attendees as per block 565. The client devices of the prospective attendees then receive the invitations via network infrastructure 120 as per block 570. Each attendee's client device displays event invitation window 400. Invitation window 400 includes the option to accept the invitation, namely ACCEPT checkbox 405, and the option to decline the invitation, namely DECLINE checkbox 410. Invitation window 400 includes an attendee IM setting panel 400A that includes a TURN IM OFF DURING EVENT option, namely checkbox 415, and the RESTRICT EXTERNAL IM DURING EVENT option, namely checkbox 420. The attendee's client device displays the TURN IM OFF DURING EVENT option and the RESTRICT EXTERNAL IM DURING EVENT option as per blocks 575 and 580, respectively. When the event organizer restricts external IM, then system 100 permits internal IM, namely IM among event attendees. An attendee who receives the invitation either accepts the invitation by selecting checkbox 405 or declines the invitation by selecting checkbox 410 as per block 585. Upon such acceptance or declination, the attendee's client device sends the accepted or declined invitation to calendar application server 110 as per block 590. Calendar server application 130 in calendar server 110 stores the accepted and declined invitations as per block 595. Thus, calendar server 110 maintains a record of all scheduled events including event parameters such as the subject, date and time information, attendees and IM restriction information. The IM restriction information stored by calendar server 110 includes both IM restriction information entered by the meeting organizer and IM restriction information entered by the attendees.

Returning to decision block 520 in FIG. 5A, if the event organizer does not select the restrict IM option 310, then process flow continues directly to block 565. At block 565, system 100 transmits event invitations to the specified attendees and process flow continues in the manner already discussed above.

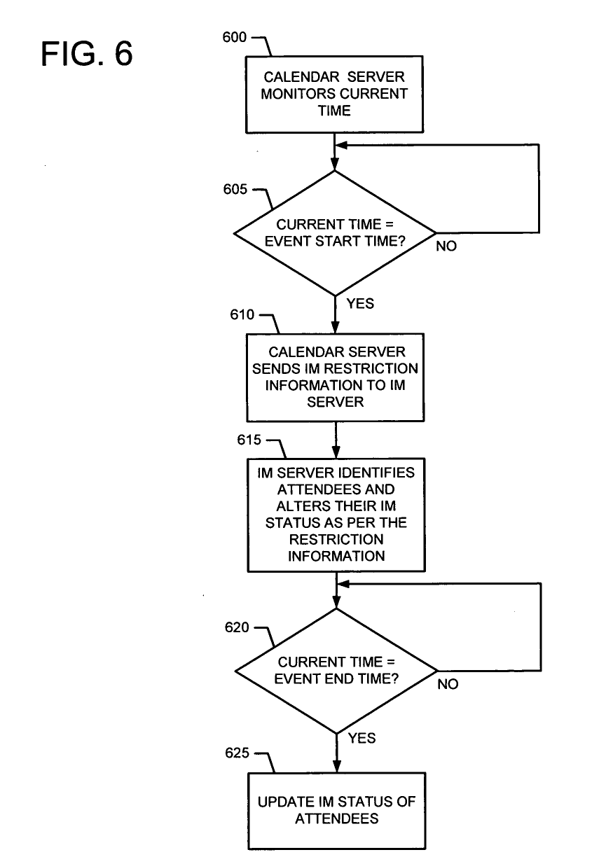

FIG. 6 shows a flowchart that depicts the operation of calendar server 110, IM server 105 and client devices 1, 2, 3 . . . N once the attendees accept or decline the invitations and after calendar server 110 stores the accepted or declined invitations. After the event organizer schedules a meeting that calendar server application 130 stores in calendar server 110, calendar server 110 monitors the current time to determine when the scheduled time for an event occurs, as per block 600. More specifically, calendar application 110 conducts a test to determine if the current time equals the event start time as per decision block 605. If the current time does not equal the event start time, then calendar server application 130 continues to monitor the time. However, once calendar server application 130 determines that the current time equals the start time of a scheduled event, then process flow continues to block 610. When the scheduled event time arrives, calendar server 110 sends the IM restriction information for that event to IM server 105 as per block 610. IM server 105 then identifies the attendees for the particular event and alters their IM capabilities and status as per the restriction information for that event.

In one embodiment, the IM restriction information may specify that all IM activity by attendees cease during the meeting. In this scenario, IM server application 115 may instruct each attendee's IM client applications 125 to display a busy status for the attendee or may show the attendee to be offline. Alternatively, the IM restriction information may specify that the attendees may engage in IM with one other, but not with IM users external to the event. In yet another embodiment, the IM restriction information may specify that the IM server automatically broadcast the IM activity of any event attendee to all of the other event attendees. In yet another embodiment, the IM restriction information may specify that non-attendee IM users may override IM restriction settings for urgent matters. In still another embodiment, the IM restriction information may specify that the IM server 105 allow external IM by selected attendees. In yet another embodiment, the IM restriction information may specify that the IM server 105 allow internal IM by selected attendees and exclude IM with users external to the event, namely IM with non-attendees.

During the event, calendar server 110 continues to monitor the current time to determine when the current time equals the event end time as per decision block 620. If the current time does not equal the event and time, then calendar server 110 continues monitoring the current time. However, when calendar server 110 determines that the current time equals the event end time, then process flow continues to block 625. At block 625 the IM status of the attendees is updated to indicate that the attendees may now IM without restriction.

Those skilled in the art will appreciate that the methodology disclosed, such as seen in the flow charts of FIGS. 5A, 5B and 6 and the representative windows of FIGS. 3A-3F and FIG. 4, can be implemented in hardware or software. Moreover, the disclosed methodology may be embodied in a computer program product, such as a media disk, media drive or other storage media, or may be divided among multiple computer program products.

In one embodiment, the disclosed methodology is implemented as server and client applications, namely sets of instructions (program code) in code modules which may, for example, be resident in the system memory 215 of system 200 of FIG. 2. As explained above, system 200 may be configured as instant messaging server 105, calendar application server 110, or a client device such as client device 1. The particular program code for each of these servers or client devices varies according to the functionality previously described for that particular server or client device. Until required by the particular system 200, the set of instructions or program code may be stored in another memory, for example, non-volatile storage 230 such as a hard disk drive, or in a removable memory such as an optical disk or floppy disk, or downloaded via the Internet or other computer network. Thus, the disclosed methodology may be implemented in respective computer program products for use in servers 105 and 110 or in client devices 1, 2, 3 . . . N. It is noted that in such a software embodiment, code which carries out the functions described in the flow charts of FIGS. 5A, 5B and 6 and depicted in FIGS. 3A-3F and FIG. 4 may be stored in RAM or system memory 215 while such code is being executed. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

The foregoing discloses an instant messaging client-server network system wherein a calendar server application stores scheduled event information and restriction information that specifies restrictions on the IM capabilities of attendees during the event. In one embodiment the event organizer initiates an IM restriction stored in the restriction information and in another embodiment an event attendee initiates an IM restriction stored in the restriction information.

Modifications and alternative embodiments of this invention will be apparent to those skilled in the art in view of this description of the invention. Accordingly, this description teaches those skilled in the art the manner of carrying out the invention and is intended to be construed as illustrative only. The forms of the invention shown and described constitute the present embodiments. Persons skilled in the art may make various changes in the shape, size and arrangement of parts. For example, persons skilled in the art may substitute equivalent elements for the elements illustrated and described here. Moreover, persons skilled in the art after having the benefit of this description of the invention may use certain features of the invention independently of the use of other features, without departing from the scope of the invention.

What is claimed is:

1. A method of operating instant messaging (IM) in a network including a plurality of client devices, the method comprising:
scheduling, by a calendar server application, an event in which selected IM users are scheduled to participate as event attendees via the client devices;
transmitting, by the calendar server application, IM restriction information to an IM server application; and
restricting, by the IM server application, the IM capability of event attendees' client devices during the event as specified by the IM restriction information.

2. The method of claim 1, wherein the restricting step comprises transmitting, by the IM server application, the IM restriction information to client devices of IM users.

3. The method of claim 1, wherein the scheduling step comprises transmitting, by an IM user's client device, the IM restriction information to the calendar server.

4. The method of claim 3, wherein the IM user's client device is configured for use by an event organizer.

5. The method of claim 3, wherein the IM user's client device is configured for use by an event attendee.

6. The method of claim 1, wherein the IM restriction information specifies that event attendees may IM only with other event attendees during the event.

7. The method of claim 1 wherein the IM restriction information specifies disabling IM activity by event attendees during the event such that no IM occurs during the event.

8. The method of claim 1 wherein the IM restriction information specifies that selected attendees may IM with non-attendees during the event.

9. The method of claim 1 wherein the IM restriction information specifies that IM activity of an attendee is automatically transmitted to other attendees during the event.

10. The method of claim 1 wherein the calendar server application and the IM server application are configured in one of first and second configurations, the first configuration including a common server that executes both the calendar server application and the IM server application, the second configuration including a calendar server that executes the calendar server application and an IM server that executes the IM server application.

11. A network system including a server to which client devices are couplable, the server comprising:
a server processor;
a server storage, coupled to the server processor, containing application code that when executed by the server processor enables the following actions:
hosting, by the server, an instant messaging session in which the client devices participate, the client devices being operable by respective client device users;
storing, by the server, calendars of events for the respective client device users, the calendars including a list of attendees for a particular event;
storing, by the server, IM restriction information that limits IM activity of attendees during the particular event;
monitoring, by the server, the calendars of events to determine if any of the client device users is scheduled as an attendee for the particular event at the present time; and
transmitting, by the server, the IM restriction information to the client devices of users scheduled as attendees of the particular event to limit the IM activity of the attendees during the event.

12. The system of claim 11, wherein the IM user's client device is configured for use by an event organizer.

13. The system of claim 11, wherein the IM user's client device is configured for use by an event attendee.

14. The system of claim 11, wherein the IM restriction information specifies that event attendees may IM only with other event attendees during the event.

15. The system of claim 11, wherein the IM restriction information specifies disabling IM activity by event attendees during the event.

16. The system of claim 11, wherein the IM restriction information specifies that selected attendees may IM with non-attendees during the event.

17. The system of claim 11, wherein the IM restriction information specifies that IM activity of an attendee is automatically transmitted to other attendees during the event.

18. A computer program product stored on a computer operable medium for instant messaging (IM), the computer program product comprising:
instructions for hosting, by a server, an instant messaging session in which client devices participate, the client devices being operable by respective client device users;
instructions for storing, by the server, calendars of events for the respective client device users, the calendars including a list of attendees for a particular event;
instructions for storing, by the server, IM restriction information that limits IM activity of attendees during the particular event;
instructions for monitoring, by the server, the calendars of events to determine if any of the client device users is scheduled as an attendee for the particular event at the present time; and
instructions for transmitting, by the server, the IM restriction information to the client devices of users scheduled as attendees of the particular event to limit the IM activity of the attendees during the event.

19. The computer program of claim 18, wherein the IM restriction information specifies that event attendees may IM only with other event attendees during the event.

20. The computer program of claim 18, wherein the IM restriction information specifies disabling IM activity by event attendees during the event.
